(19) United States
(12) Patent Application Publication
(10) Pub. No.: US 2013/0149546 A1
(43) Pub. Date: Jun. 13, 2013

(54) METHOD OF MANUFACTURING POLARIZING FILM

(71) Applicant: NITTO DENKO CORPORATION, Osaka (JP)

(72) Inventors: Tomohiro Mori, Ibaraki-shi (JP); Minoru Miyatake, Ibaraki-shi (JP); Takashi Kamijo, Ibaraki-shi (JP); Shusaku Goto, Ibaraki-shi (JP); Takeharu Kitagawa, Ibaraki-shi (JP)

(73) Assignee: NITTO DENKO CORPORATION, Osaka (JP)

(21) Appl. No.: 13/652,908

(22) Filed: Oct. 16, 2012

(30) Foreign Application Priority Data
Dec. 12, 2011 (JP) 2011-270953

(51) Int. Cl. G02B 1/10; B32B 27/08

(52) U.S. Cl. 428/500; 427/163.1

(57) ABSTRACT

A method of manufacturing a polarizing film according to an embodiment of the present invention includes forming a polyvinyl alcohol-based resin layer on a thermoplastic resin substrate having a crystallinity of 7% or less to produce a laminate and subjecting the laminate to a wet treatment followed by a drying treatment with a heat roll.

This application claims priority under 35 U.S.C. Section 119 to Japanese Patent Application No. 2011-270953 filed on Dec. 12, 2011, which are herein incorporated by references.

### FIELD OF THE INVENTION

The present invention relates to a method of manufacturing a polarizing film.

### DESCRIPTION OF THE RELATED ART

A polarizing film is placed on each of both sides of the liquid crystal cell of a liquid crystal display apparatus as a representative image display apparatus, the placement being attributable to the image-forming mode of the apparatus. For example, the following method has been proposed as a method of manufacturing the polarizing film (for example, JP 2001-343521 A). A laminate having a thermoplastic resin substrate and a polyvinyl alcohol (PVA)-based resin layer is stretched, and is then immersed in a dyeing liquid so that the polarizing film may be obtained. According to such method, a polarizing film having a small thickness is obtained. Accordingly, the method has been attracting attention because of its potential to contribute to the thinning of a recent liquid crystal display apparatus.

Meanwhile, the polarizing film is generally produced through a step of immersing a PVA-based resin film in an aqueous solution (wet step) and a drying step. However, as described above, when the polarizing film is produced with the thermoplastic resin substrate, curling (specifically, convex curling on a thermoplastic resin substrate side) is liable to occur during drying, which causes a problem of a failure in external appearance of the resultant polarizing film.

### SUMMARY OF THE INVENTION

The present invention has been made in order to solve the conventional problem. A main object of the present invention is to provide a method of manufacturing a polarizing film excellent in external appearance by suppressing curling.

According to one aspect of the present invention, a method of manufacturing a polarizing film is provided. The method of manufacturing a polarizing film includes forming a polyvinyl alcohol-based resin layer on a thermoplastic resin substrate having a crystallinity of 7% or less to produce a laminate and subjecting the laminate to a wet treatment followed by a drying treatment with a heat roll.

In one embodiment of the present invention, the thermoplastic resin substrate includes a polyethylene terephthalate-based resin.

In another embodiment of the present invention, the polyethylene terephthalate-based resin has an isophthalic acid unit.

In still another embodiment of the present invention, a content ratio of the isophthalic acid unit is 0.1 mol % or more and 20 mol % or less with respect to a total of all repeating units.

In still another embodiment of the present invention, the heat roll has a temperature of 50° C. or more.

In still another embodiment of the present invention, the heat roll has a temperature of 80° C. or more.

In still another embodiment of the present invention, the thermoplastic resin substrate after the drying treatment has a crystallinity of 15% or more.

In still another embodiment of the present invention, the thermoplastic resin substrate after the drying treatment has a crystallinity of 20% or more.

In still another embodiment of the present invention, the crystallinity of the thermoplastic resin substrate is increased through the drying treatment by 2% or more.

In still another embodiment of the present invention, the wet treatment includes a stretching treatment performed by immersing the laminate in an aqueous solution of boric acid.

According to another aspect of the present invention, a polarizing film is provided. The polarizing film is obtained by the method of manufacturing a polarizing film.

According to still another aspect of the present invention, an optical laminate is provided. The optical laminate includes the polarizing film.

In one embodiment of the present invention, the optical laminate further includes the thermoplastic resin substrate.

According to the present invention, curling can be suppressed by producing a laminate with a thermoplastic resin substrate having a crystallinity of 7% or less and subjecting the laminate to a wet treatment followed by drying with a heat roll. Specifically, the crystallinity of the thermoplastic resin substrate can be increased by efficiently promoting the crystallization of the thermoplastic resin substrate. The crystallinity of the thermoplastic resin substrate can be satisfactorily increased even at a relatively low drying temperature. As a result, the thermoplastic resin substrate has increased rigidity and thus has the potential to resist contraction of a PVA-based resin layer due to drying, leading to the suppression of curling. In addition, through the use of the heat roll, the laminate can be dried while being maintained in a flat state, and hence the occurrence of wrinkling as well as curling can be suppressed. Thus, the polarizing film excellent in external appearance can be manufactured.

### BRIEF DESCRIPTION OF THE DRAWINGS

In the accompanying drawings:

FIG. 1 is a schematic sectional view of a laminate according to a preferred embodiment of the present invention;

FIG. 2 is a schematic view illustrating an example of a drying treatment of a method of manufacturing a polarizing film according to the present invention;

FIG. 3 is a schematic view illustrating an example of a method of manufacturing a polarizing film according to the present invention;

FIG. 4 are each a schematic sectional view of an optical film laminate according to a preferred embodiment of the present invention;

FIG. 5 are each a schematic sectional view of an optical functional film laminate according to another preferred embodiment of the present invention; and

FIG. 6 are observation photographs of optical laminates according to Examples and Comparative Examples of the present invention.

### DETAILED DESCRIPTION OF THE INVENTION

Hereinafter, preferred embodiments of the present invention are described. However, the present invention is not limited to these embodiments.

### A. Manufacturing Method

A method of manufacturing a polarizing film according to the present invention includes forming a PVA-based resin layer on a thermoplastic resin substrate to produce a laminate and subjecting the laminate to a wet treatment and a drying treatment. The laminate is typically a long laminate.

A-1. Production of Laminate

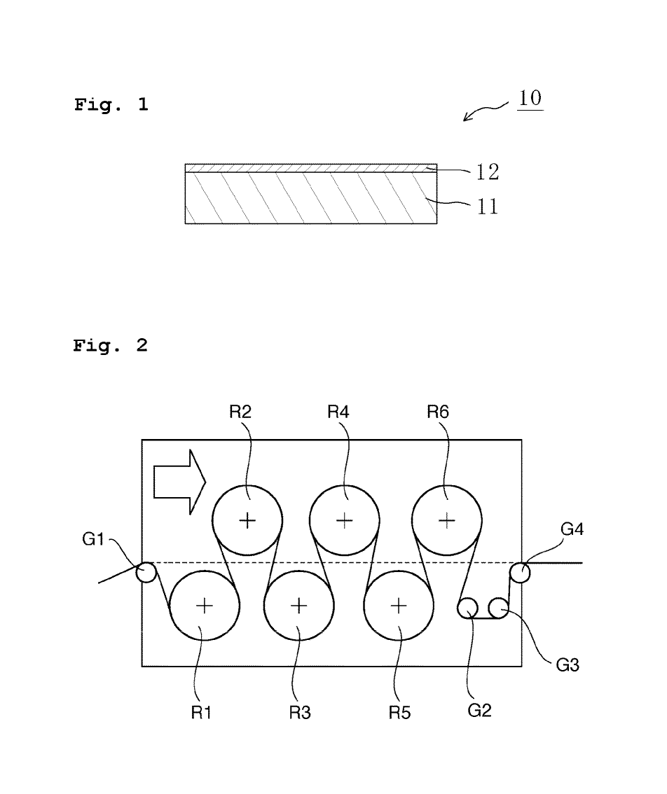

FIG. 1 is a schematic sectional view of a laminate according to a preferred embodiment of the present invention. A laminate 10 has a thermoplastic resin substrate 11 and a PVA-based resin layer 12, and is produced by forming the PVA-based resin layer 12 on the thermoplastic resin substrate. Any appropriate method can be adopted as a method of forming the PVA-based resin layer 12. The PVA-based resin layer 12 is preferably formed by applying an application liquid containing a PVA-based resin onto the thermoplastic resin substrate 11 and drying the liquid.

The thermoplastic resin substrate has a crystallinity (before a drying treatment) of preferably 7% or less, more preferably 5% or less. Such thermoplastic resin substrate can have an increased crystallinity by virtue of the promotion of crystallization in the drying treatment. As a result, the thermoplastic resin substrate has increased rigidity and thus has the potential to resist contraction of a PVA-based resin layer due to drying, leading to the suppression of curling. In addition, the laminate can be satisfactorily stretched through the use of such thermoplastic resin substrate. Specifically, when the laminate is immersed in a stretching bath (e.g., an aqueous solution of boric acid) and subjected to underwater stretching as described later, its stretching tension lowers and its stretching property improves. It should be noted that the “crystallinity” as used herein refers to a value calculated by measuring a quantity of heat of crystal fusion at a rate of temperature increase of 10° C./min with a DSC apparatus, and dividing a difference between the quantity of heat of crystal fusion and a quantity of heat of crystal formation at the time of the measurement by a quantity of heat of fusion for a perfect crystal (literature value).

The percentage of water absorption of the thermoplastic resin substrate is preferably 0.2% or more, more preferably 0.3% or more. The thermoplastic resin substrate absorbs water and the water serves a plastic function so that the substrate can plasticize. As a result, a stretching stress can be significantly reduced and the stretching can be performed at a high ratio. Meanwhile, the percentage of water absorption of the thermoplastic resin substrate is preferably 3.0% or less, more preferably 1.0% or less. The use of such thermoplastic resin substrate can prevent, for example, the following inconvenience. The dimensional stability of the thermoplastic resin substrate remarkably reduces at the time of the production and hence the external appearance of the polarizing film to be obtained deteriorates. In addition, the use can prevent the rupture of the substrate at the time of the underwater stretching and the release of the PVA-based resin layer from the thermoplastic resin substrate. It should be noted that the percentage of water absorption of the thermoplastic resin substrate can be adjusted by, for example, introducing a denaturation group into the constituent material. The percentage of water absorption is a value determined in conformity with JIS K 7209.

The glass transition temperature (Tg) of the thermoplastic resin substrate is preferably 170° C. or less. The use of such thermoplastic resin substrate can sufficiently secure the stretchability of the laminate while suppressing the crystallization of the PVA-based resin layer. Further, the glass transition temperature is more preferably 120° C. or less in consideration of the plasticization of the thermoplastic resin substrate by water and favorable performance of the underwater stretching. Meanwhile, the glass transition temperature of the thermoplastic resin substrate is preferably 60° C. or more. The use of such thermoplastic resin substrate prevents an inconvenience such as the deformation of the thermoplastic resin substrate (e.g., the occurrence of unevenness, a slack, or wrinkling) during the application and drying of the application liquid containing the PVA-based resin, thereby enabling favorable production of the laminate. In addition, the use enables favorable stretching of the PVA-based resin layer at a suitable temperature (e.g., about 60° C.). It should be noted that the glass transition temperature of the thermoplastic resin substrate can be adjusted by, for example, introducing a denaturation group into the constituent material or heating the substrate constituted of a crystallization material. The glass transition temperature (Tg) is a value determined in conformity with JIS K 7121.

Any appropriate material can be adopted as a constituent material for the thermoplastic resin substrate as long as the crystallinity of the thermoplastic resin substrate falls within the above-mentioned range. The crystallinity can be adjusted, for example, by introducing a modification group into the constituent material. An amorphous (uncrystallized) polyethylene terephthalate-based resin is preferably used as the constituent material for the thermoplastic resin substrate. Of those, a noncrystalline (hardly crystallizable) polyethylene terephthalate-based resin is particularly preferably used. Specific examples of the noncrystalline polyethylene terephthalate-based resin include a copolymer further containing isophthalic acid and/or cyclohexanedicarboxylic acid as a dicarboxylic acid, and a copolymer further containing cyclohexanedimethanol or diethylene glycol as a glycol.

In a preferred embodiment, the thermoplastic resin substrate is formed of a polyethylene terephthalate-based resin having an isophthalic acid unit, because such thermoplastic resin substrate is extremely excellent in stretching property and crystallization at the time of stretching can be suppressed. This is probably attributable to the fact that the introduction of the isophthalic acid unit imparts high flexibility to a main chain. The polyethylene terephthalate-based resin has a terephthalic acid unit and an ethylene glycol unit. The content ratio of the isophthalic acid unit is preferably 0.1 mol % or more, more preferably 1.0 mol % or more, with respect to the total of all repeating units, because the thermoplastic resin substrate extremely excellent in stretching property is obtained. Meanwhile, the content ratio of the isophthalic acid unit is preferably 20 mol % or less, more preferably 10 mol % or less, with respect to the total of all repeating units. The control of the content ratio within such range allows the crystallinity to be satisfactorily increased in a drying treatment to be described later.

The thickness of the thermoplastic resin substrate before the stretching is preferably 20 μm to 300 μm, more preferably 50 μm to 200 μm. When the thickness is less than 20 μm, it may be difficult to form the PVA-based resin layer. When the thickness exceeds 300 μm, in, for example, an underwater stretching treatment to be described later, it may take a longtime for the thermoplastic resin substrate to absorb water, and an excessively large load may be needed in the stretching.

Any appropriate resin can be adopted as the PVA-based resin. Examples of the resin include a polyvinyl alcohol and an ethylene-vinyl alcohol copolymer. The polyvinyl alcohol is obtained by saponifying a polyvinyl acetate. The ethylene-vinyl alcohol copolymer is obtained by saponifying an ethylene-vinyl acetate copolymer. The saponification degree of the PVA-based resin is typically 85 mol % to 100 mol %, preferably 95.0 mol % to 99.95 mol %, more preferably 99.0 mol % to 99.93 mol %. The saponification degree can be determined in conformity with JIS K 6726-1994. The use of the PVA-based resin having such saponification degree can provide a polarizing film excellent in durability. When the saponification degree is excessively high, the resin may gel.

The average polymerization degree of the PVA-based resin can be appropriately selected depending on purposes. The average polymerization degree is typically 1,000 to 10,000, preferably 1,200 to 4,500, more preferably 1,500 to 4,300. It should be noted that the average polymerization degree can be determined in conformity with JIS K 6726-1994.

The application liquid is representatively a solution prepared by dissolving the PVA-based resin in a solvent. Examples of the solvent include water, dimethylsulfoxide, dimethylformamide, dimethylacetamide, N-methylpyrrolidone, various glycols, polyhydric alcohols such as trimethylolpropane, and amines such as ethylenediamine and diethylenetriamine. One kind of those solvents can be used alone, or two or more kinds thereof can be used in combination. Of those, water is preferred. The concentration of the PVA-based resin of the solution is preferably 3 parts by weight to 20 parts by weight with respect to 100 parts by weight of the solvent. At such resin concentration, a uniform coating film in close contact with the thermoplastic resin substrate can be formed.

The application liquid may be compounded with an additive. Examples of the additive include a plasticizer and a surfactant. Examples of the plasticizer include polyhydric alcohols such as ethylene glycol and glycerin. Examples of the surfactant include nonionic surfactants. Such additive can be used for the purpose of additionally improving the uniformity, dyeing property, or stretching property of the PVA-based resin layer to be obtained.

Any appropriate method can be adopted as a method of applying the application liquid. Examples of the method include a roll coating method, a spin coating method, a wire bar coating method, a dip coating method, a die coating method, a curtain coating method, a spray coating method, and a knife coating method (comma coating method or the like).

The application liquid is preferably applied and dried at a temperature of 50° C. or more.

The thickness of the PVA-based resin layer before the stretching is preferably 3 μm to 40 μm, more preferably 3 μm to 20 μm.

The thermoplastic resin substrate may be subjected to a surface treatment (such as a corona treatment) before the formation of the PVA-based resin layer. Alternatively, an easy-adhesion layer may be formed on the thermoplastic resin substrate. Performing such treatment can improve adhesiveness between the thermoplastic resin substrate and the PVA-based resin layer.

A-2. Wet Treatment

The wet treatment is typically a treatment of immersing the laminate in an aqueous solution. Examples of the wet treatment include a dyeing treatment, a stretching treatment, an insolublizing treatment, a cross-linking treatment, and a washing treatment. Those treatments may be selected depending on purposes. In addition, treatment conditions such as treatment order, treatment timing, and treatment frequency can be appropriately set. The respective treatments are described below.

The dyeing treatment is typically performed by dyeing a PVA-based resin layer with iodine. Specifically, the dyeing treatment is performed by causing the PVA-based resin layer to adsorb iodine. Examples of the adsorption method include a method involving immersing a PVA-based resin layer (laminate) in a dyeing liquid containing iodine, a method involving applying the dyeing liquid onto a PVA-based resin layer, and a method involving spraying the dyeing liquid onto a PVA-based resin layer. Of those, the method involving immersing a laminate in a dyeing liquid is preferably employed because iodine can be satisfactorily adsorbed.

The dyeing liquid is preferably an aqueous solution of iodine. The compounding amount of iodine is preferably 0.1 part by weight to 0.5 part by weight with respect to 100 parts by weight of water. The aqueous solution of iodine is preferably compounded with an iodide in order that the solubility of iodine in water may be increased. Examples of the iodide include potassium iodide, lithium iodide, sodium iodide, zinc iodide, aluminum iodide, lead iodide, copper iodide, barium iodide, calcium iodide, tin iodide, and titanium iodide. Of those, potassium iodide is preferred. The compounding amount of the iodide is preferably 0.02 part by weight to 20 parts by weight, more preferably 0.1 part by weight to 10 parts by weight with respect to 100 parts by weight of water. The liquid temperature of the dyeing liquid at the time of the dyeing is preferably 20° C. to 50° C. in order that the dissolution of the PVA-based resin may be suppressed. When the PVA-based resin layer is immersed in the dyeing liquid, an immersion time is preferably 5 seconds to 5 minutes in order that the transmittance of the PVA-based resin layer may be secured. In addition, the dyeing conditions (the concentration, the liquid temperature, and the immersion time) can be set so that the polarization degree or single axis transmittance of the polarizing film to be finally obtained may fall within a predetermined range. In one embodiment, the immersion time is set so that the polarization degree of the polarizing film to be obtained may be 99.98% or more. In another embodiment, the immersion time is set so that the single axis transmittance of the polarizing film to be obtained may be 40% to 44%.

The stretching treatment is preferably performed by immersing the laminate in a stretching bath (underwater stretching). According to the underwater stretching, the stretching can be performed at a temperature lower than the glass transition temperature (representatively about 80° C.) of each of the thermoplastic resin substrate and the PVA-based resin layer, and hence the PVA-based resin layer can be stretched at a high ratio while its crystallization is suppressed. As a result, a polarizing film having excellent optical characteristics (such as a polarization degree) can be manufactured.

Any appropriate method can be adopted as a method of stretching the laminate. Specifically, fixed-end stretching may be adopted, or free-end stretching (such as a method involving passing the laminate between rolls having different peripheral speeds to uniaxially stretch the laminate) may be adopted. The stretching of the laminate may be performed in one stage, or may be performed in a plurality of stages. When the stretching is performed in a plurality of stages, the stretching ratio (maximum stretching ratio) of the laminate to be described later is the product of stretching ratios in the respective stages.

The under water stretching is preferably performed by immersing the laminate in an aqueous solution of boric acid (boric acid underwater stretching). The use of the aqueous solution of boric acid as the stretching bath can impart, to the PVA-based resin layer, rigidity enough to withstand a tension to be applied at the time of the stretching and such water resistance that the layer does not dissolve in water. Specifically, boric acid can produce a tetrahydroxyborate anion in the aqueous solution to cross-link with the PVA-based resin through a hydrogen bond. As a result, the PVA-based resin layer can be favorably stretched with the aid of the rigidity and the water resistance imparted thereto, and hence a polarizing film having excellent optical characteristics (such as a polarization degree) can be manufactured.

The aqueous solution of boric acid is preferably obtained by dissolving boric acid and/or a borate in water as a solvent. The concentration of boric acid is preferably 1 part by weight to 10 parts by weight with respect to 100 parts by weight of water. Setting the concentration of boric acid to 1 part by weight or more can effectively suppress the dissolution of the PVA-based resin layer, thereby enabling the production of a polarizing film having additionally high characteristics. It should be noted that an aqueous solution obtained by dissolving a boron compound such as borax, glyoxal, glutaric aldehyde, or the like as well as boric acid or the borate in the solvent can also be used.

The stretching bath (aqueous solution of boric acid) is preferably compounded with an iodide. Compounding the bath with the iodide can suppress the elution of iodine which the PVA-based resin layer has been caused to adsorb. Specific examples of the iodide are as described above. The concentration of the iodide is preferably 0.05 part by weight to 15 parts by weight, more preferably 0.5 part by weight to 8 parts by weight with respect to 100 parts by weight of water.

The stretching temperature (liquid temperature of a stretching bath) is preferably 40° C. to 85° C., more preferably 50° C. to 85° C. At such temperature, the PVA-based resin layer can be stretched at a high ratio while its dissolution is suppressed. Specifically, as described above, the glass transition temperature (Tg) of the thermoplastic resin substrate is preferably 60° C. or more in relation to the formation of the PVA-based resin layer. In this case, when the stretching temperature falls short of 40° C., there is a possibility that the stretching cannot be favorably performed even in consideration of the plasticization of the thermoplastic resin substrate by water. On the other hand, as the temperature of the stretching bath increases, the solubility of the PVA-based resin layer is raised and hence excellent optical characteristics may not be obtained. The laminate is preferably immersed for 15 seconds to 5 minutes in the stretching bath.

The stretching ratio by the underwater stretching is preferably 1.5 times or more, more preferably 3.0 times or more. The maximum stretching ratio of the laminate is preferably 5.0 times or more with respect to the original length of the laminate. By achieving such high ratio, a polarizing film extremely excellent in optical characteristics can be manufactured. Such high stretching ratio can be achieved by adopting the underwater stretching mode (boric acid underwater stretching). It should be noted that the term “maximum stretching ratio” as used herein refers to a stretching ratio immediately before the rupture of the laminate. The stretching ratio at which the laminate ruptures is separately identified and a value lower than the value by 0.2 is the maximum stretching ratio.

The underwater stretching treatment is preferably conducted after the dyeing treatment.

The insolubilizing treatment is representatively performed by immersing the PVA-based resin layer in an aqueous solution of boric acid. Water resistance can be imparted to the PVA-based resin layer by subjecting the layer to the insolubilizing treatment. The concentration of the aqueous solution of boric acid is preferably 1 part by weight to 4 parts by weight with respect to 100 parts by weight of water. The liquid temperature of an insolubilizing bath (the aqueous solution of boric acid) is preferably 20° C. to 50° C. The insolubilizing treatment is preferably performed after the production of the laminate and before the dyeing treatment or the underwater stretching treatment.

The cross-linking treatment is representatively performed by immersing the PVA-based resin layer in an aqueous solution of boric acid. Water resistance can be imparted to the PVA-based resin layer by subjecting the layer to the cross-linking treatment. The concentration of the aqueous solution of boric acid is preferably 1 part by weight to 4 parts by weight with respect to 100 parts by weight of water. In addition, when the cross-linking treatment is performed after the dyeing treatment, the solution is preferably further compounded with an iodide. Compounding the solution with the iodide can suppress the elution of iodine which the PVA-based resin layer has been caused to adsorb. The compounding amount of the iodide is preferably 1 part by weight to 5 parts by weight with respect to 100 parts by weight of water. Specific examples of the iodide are as described above. The liquid temperature of a cross-linking bath (the aqueous solution of boric acid) is preferably 20° C. to 50° C. The cross-linking treatment is preferably performed before the underwater stretching treatment. In a preferred embodiment, the dyeing treatment, the cross-linking treatment, and the underwater stretching treatment are performed in the stated order.

The washing treatment is representatively performed by immersing the PVA-based resin layer in an aqueous solution of potassium iodide.

A-3. Drying Treatment

The drying treatment is performed by heating a conveying roll (using a so-called heat roll) (heat roll drying mode). A polarizing film excellent in external appearance can be manufactured by suppressing curling through drying with a heat roll. Specifically, when the laminate is dried while being placed in contact with the heat roll, the crystallization of the thermoplastic resin substrate can be efficiently promoted to increase the crystallinity. The crystallinity of the thermoplastic resin substrate can be satisfactorily increased even at a relatively low drying temperature. As a result, the thermoplastic resin substrate has increased rigidity and thus has the potential to resist contraction of a PVA-based resin layer due to drying, leading to the suppression of curling. In addition, through the use of the heat roll, the laminate can be dried while being maintained in a flat state, and hence the occurrence of wrinkling as well as curling can be suppressed.

The wet treatment preferably includes the underwater stretching (boric acid underwater stretching) treatment. According to such embodiment, as described above, a high stretching ratio can be achieved to enhance the orientation property of the thermoplastic resin substrate. When heat is applied to the thermoplastic resin substrate having high orientation property through the drying treatment, the crystallinity can markedly increase by virtue of the rapid progress of crystallization. The crystallinity of the thermoplastic resin substrate after the underwater stretching (boric acid underwater stretching) treatment is preferably about 10% to 15%.

FIG. 2 is a schematic view illustrating an example of the drying treatment. In the example illustrated in the figure, conveying rolls R1 to R6 are continuously provided so that a central angle θ corresponding to a contact surface between the laminate 10 and each of the conveying rolls may be 180° or more. A guide roll G1 is provided, followed by the conveying roll R1 on the upstream side, and guide rolls G2 to G4 are provided, following the conveying roll R6 on the downstream side. The laminate 10 conveyed with the guide roll G1 is dried while being conveyed with each of the conveying rolls R1 to R6 heated to a predetermined temperature, and is sent to a straight path through the guide rolls G2 to G4.

Drying conditions can be controlled by adjusting the heating temperature of the conveying rolls (temperature of the heat rolls), the number of the heat rolls, a time of contact with the heat rolls, and the like. The temperature of the heat rolls is preferably 50° C. or more, more preferably 80° C. or more. Thus, curling can be satisfactorily suppressed by satisfactorily increasing the crystallinity of the thermoplastic resin substrate. In addition, an optical laminate extremely excellent in durability can be manufactured. Meanwhile, the temperature of the heat rolls is preferably 130° C. or less. A defect such as deterioration of optical characteristic of the optical laminate obtained by drying can be prevented. It should be noted that the temperature of the heat rolls can be measured with a contact type temperature gauge. In the example illustrated in the figure, six conveying rolls are provided, but the number of the conveying rolls is not particularly limited as long as the number of the conveying rolls is multiple. The number of the conveying rolls to be provided is generally 2 to 40, preferably 4 to 30. A time of contact (total time of contact) between the laminate and the heat rolls is preferably 1 second to 300 seconds.

The heat rolls may be provided in a heating furnace (e.g., an oven), or may be provided in a general manufacturing line (under a room temperature environment). The heat rolls are preferably provided in a heating furnace equipped with blowing means. When the drying with the heat rolls and drying with hot air are used in combination, a steep change in temperature between heat rolls can be suppressed, and contraction in a widthwise direction can be easily controlled. A hot air drying temperature is preferably 30° C. to 100° C. In addition, a hot air drying time is preferably 1 second to 300 seconds. A hot air flow rate is preferably about 10 m/s to 30 m/s. It should be noted that the flow rate is a flow rate in a heating furnace and can be measured with a mini-vane type digital anemometer.

The crystallinity of the thermoplastic resin substrate is increased through the drying treatment by preferably 2% or more, more preferably 5% or more. The thermoplastic resin substrate after the drying treatment has a crystallinity of preferably 15% or more, more preferably 20% or more. Such increase in crystallinity can suppress curling satisfactorily. In addition, an optical laminate extremely excellent in durability can be manufactured. It should be noted that the upper limit value of the crystallinity varies depending on the constituent material for the thermoplastic resin substrate.

A-4. Others

In the method of manufacturing a polarizing film according to the present invention, the laminate (PVA-based resin layer) may be subjected to any appropriate treatment in addition to the foregoing. Specific examples thereof include an aerial stretching treatment and a drying treatment different from the drying treatment using the heat rolls. The stretching temperature of the aerial stretching treatment is preferably equal to or higher than the glass transition temperature (Tg) of the thermoplastic resin substrate. The stretching ratio of aerial stretching is representatively 1.0 time to 3.5 times. A stretching method is the same as that in the underwater stretching. The timing, stretching direction, and the like of the aerial stretching treatment can be appropriately determined.

In one embodiment, the stretching temperature of the aerial stretching treatment is 95° C. or more. The aerial stretching treatment at such high temperature is preferably performed prior to the wet treatment such as the underwater stretching treatment or the dyeing step. Such aerial stretching step is hereinafter referred to as “aerial auxiliary stretching” because the step can be ranked as stretching preliminary or auxiliary to the underwater stretching (boric acid underwater stretching).

When the aerial auxiliary stretching is combined with the underwater stretching, the laminate can be stretched at an additionally high ratio in some cases. As a result, a polarizing film having additionally excellent optical characteristics (such as a polarization degree) can be produced. For example, when a polyethylene terephthalate-based resin is used as the thermoplastic resin substrate, the thermoplastic resin substrate can be stretched favorably, while its orientation is suppressed, by a combination of the aerial auxiliary stretching and the underwater stretching than that in the case of the underwater stretching alone. As the orientation property of the thermoplastic resin substrate is raised, its stretching tension increases and hence it becomes difficult to stably stretch the thermoplastic resin substrate or the thermoplastic resin substrate ruptures. Accordingly, the laminate can be stretched at an additionally high ratio by stretching the thermoplastic resin substrate while suppressing its orientation.

In addition, when the aerial auxiliary stretching is combined with the boric acid underwater stretching, the orientation property of the PVA-based resin is improved and hence the orientation property of the PVA-based resin can be improved even after the boric acid underwater stretching. Specifically, the orientation property of the PVA-based resin is improved in advance by the aerial auxiliary stretching, and hence the PVA-based resin easily cross-links with boric acid during the boric acid underwater stretching. Then, the stretching is performed in a state where boric acid serves as a junction, and hence the orientation property of the PVA-based resin is assumed to be high even after the boric acid underwater stretching. As a result, a polarizing film having excellent optical characteristics (such as a polarization degree) can be produced.

As with the underwater stretching, a stretching method for the aerial auxiliary stretching may be fixed-end stretching, or may be free-end stretching (such as a method involving passing the laminate between rolls having different peripheral speeds to uniaxially stretch the laminate). In addition, the stretching may be performed in one stage, or may be performed in a plurality of stages. When the stretching is performed in a plurality of stages, a stretching ratio to be described later is the product of stretching ratios in the respective stages. It is preferred that a stretching direction in the aerial auxiliary stretching be substantially the same as the stretching direction in the underwater stretching.

The stretching ratio in the aerial auxiliary stretching is preferably 3.5 times or less. A stretching temperature in the aerial auxiliary stretching is preferably equal to or higher than the glass transition temperature of the PVA-based resin. The stretching temperature is preferably 95° C. to 150° C. It should be noted that the maximum stretching ratio when the aerial auxiliary stretching and the underwater stretching are combined with each other is preferably 5.0 times or more, more preferably 5.5 times or more, still more preferably 6.0 times or more with respect to the original length of the laminate.

It should be noted that there is a tendency that the crystallinity of the thermoplastic resin substrate undergoes substantially no change (increase) by the aerial auxiliary stretching, which is performed prior to the underwater stretching. The reason for this is probably that the orientation property of the thermoplastic resin substrate is low at the time of carrying out the aerial auxiliary stretching. Specifically, it is estimated that, even when heat is applied to the thermoplastic resin substrate having low orientation property (by the aerial auxiliary stretching), there is substantially no change (increase) in crystallinity.

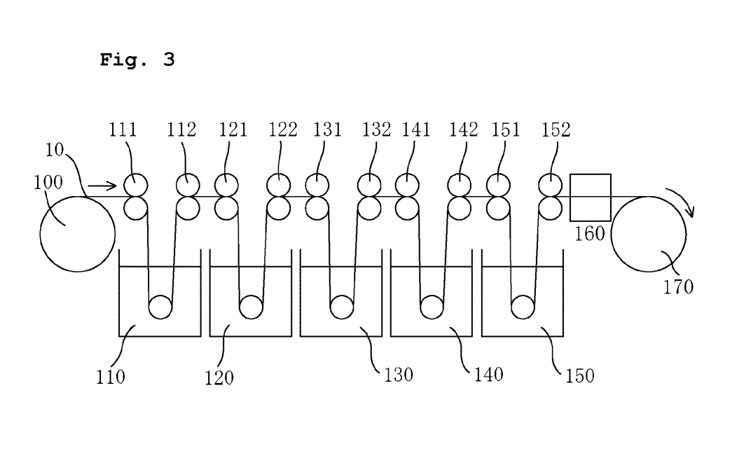

FIG. 3 is a schematic view illustrating an example of the method of manufacturing a polarizing film according to the present invention. The laminate 10 is fed from a feeding portion 100, and immersed in a bath 110 of an aqueous solution of boric acid by rolls 111 and 112 (insolublizing treatment). After that, the laminate is immersed in a bath 120 of an aqueous solution of a dichromatic substance (iodine) and potassium iodide by rolls 121 and 122 (dyeing treatment). Next, the laminate is immersed in a bath 130 of an aqueous solution of boric acid and potassium iodide by rolls 131 and 132 (cross-linking treatment). After that, the laminate 10 is stretched through the application of a tension in its longitudinal direction (lengthwise direction) with rolls 141 and 142 having different speed ratios while being immersed in a bath 140 of an aqueous solution of boric acid (underwater stretching treatment). The laminate 10 subjected to the stretching treatment is immersed in a bath 150 of an aqueous solution of potassium iodide by rolls 151 and 152 (washing treatment), and is dried in an oven 160 equipped with heat rolls (drying treatment). After that, the laminate is wound by a winding portion 170.

### B. Polarizing Film

A polarizing film of the present invention is obtained by the manufacturing method. The polarizing film of the present invention is substantially a PVA-based resin film that adsorbs and orients a dichromatic substance. The thickness of the polarizing film is representatively 25 μm or less, preferably 15 μm or less, more preferably 10 μm or less, still more preferably 7 μm or less, particularly preferably 5 μm or less. Meanwhile, the thickness of the polarizing film is preferably 0.5 μm or more, more preferably 1.5 μm or more. The polarizing film preferably shows absorption dichroism at any wavelength in the wavelength range of 380 nm to 780 nm. The single axis transmittance of the polarizing film is preferably 40.0% or more, more preferably 41.0% or more, still more preferably 42.0% or more, particularly preferably 43.0% or more. The polarization degree of the polarizing film is preferably 99.8% or more, more preferably 99.9% or more, still more preferably 99.95% or more.

Any appropriate method can be adopted as a usage of the polarizing film. Specifically, the polarizing film may be used in a state of being integrated with the thermoplastic resin substrate, or may be used after having been transferred from the thermoplastic resin substrate onto any other member.

### C. Optical Laminate

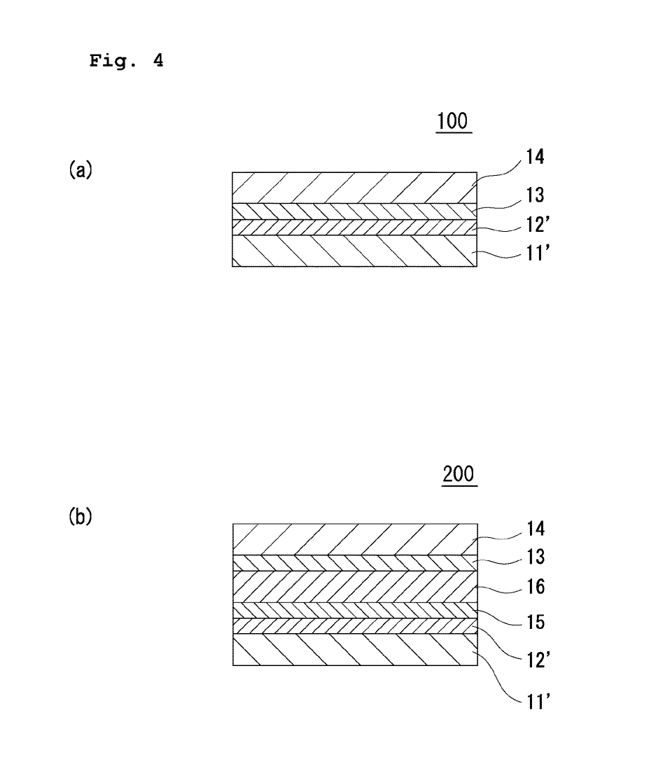

An optical laminate of the present invention has the polarizing film. FIGS. 4A and 4B are each a schematic sectional view of an optical film laminate according to a preferred embodiment of the present invention. An optical film laminate 100 has a thermoplastic resin substrate 11′, a polarizing film 12′, a pressure-sensitive adhesive layer 13, and a separator 14 in the stated order. An optical film laminate 200 has the thermoplastic resin substrate 11′, the polarizing film 12′, an adhesive layer 15, an optical functional film 16, the pressure-sensitive adhesive layer 13, and the separator 14 in the stated order. In this embodiment, the thermoplastic resin substrate is directly used as an optical member without being released from the resultant polarizing film 12′. The thermoplastic resin substrate 11′ can function as, for example, a protective film for the polarizing film 12′.

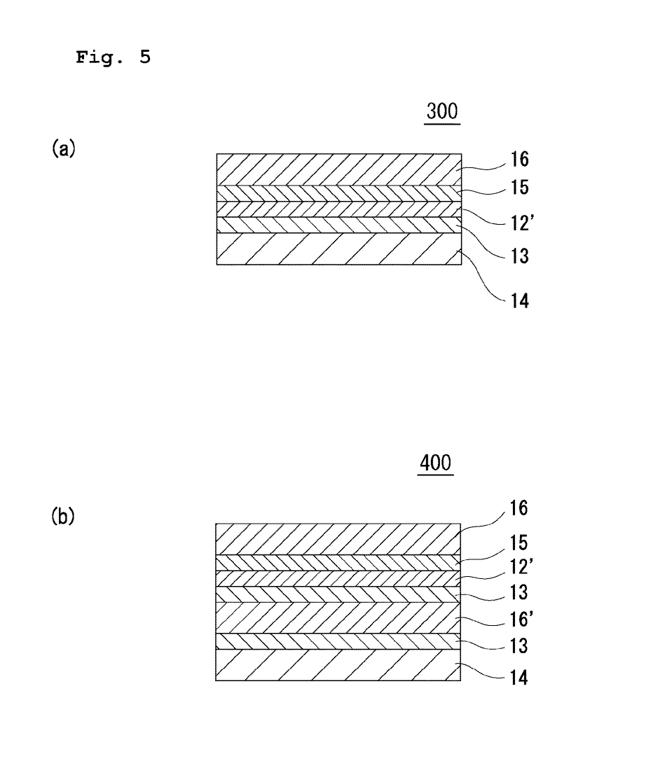

FIGS. 5A and 5B are each a schematic sectional view of an optical functional film laminate according to another preferred embodiment of the present invention. An optical functional film laminate 300 has the separator 14, the pressure-sensitive adhesive layer 13, the polarizing film 12′, the adhesive layer 15, and the optical functional film 16 in the stated order. An optical functional film laminate 400 has, in addition to the construction of the optical functional film laminate 300, a second optical functional film 16′ provided between the polarizing film 12′ and the separator 14 through the pressure-sensitive adhesive layer 13. In this embodiment, the thermoplastic resin substrate has been removed.

The lamination of the respective layers constructing the optical laminate of the present invention is not limited to the illustrated examples, and any appropriate pressure-sensitive adhesive layer or adhesive layer is used. The pressure-sensitive adhesive layer is representatively formed of an acrylic pressure-sensitive adhesive. The adhesive layer is representatively formed of a PVA-based adhesive. The optical functional film can function as, for example, a protective film for a polarizing film or a retardation film.

Hereinafter, the present invention is specifically described by way of examples. However, the present invention is not limited by these examples. It should be noted that methods of measuring the respective characteristics are as described below.

### 1. Thickness

Measurement was performed with a digital micrometer (manufactured by Anritsu Corporation, product name: “KC-351C”).

### 2. Crystallinity of Thermoplastic Resin Substrate

The crystallinity was calculated by measuring a quantity of heat of crystal fusion at a rate of temperature increase of 10° C./min with a DSC apparatus (EXSTAR DSC6000 manufactured by Seiko Instruments Inc.), and dividing a difference between the quantity of heat of crystal fusion and a quantity of heat of crystal formation at the time of the measurement by a quantity of heat of fusion for a perfect crystal (PET: 140 J/g).

### 3. Glass Transition Temperature (Tg) of Thermoplastic Resin Substrate

Measurement was performed in conformity with JIS K 7121.

### Example 1

An amorphous polyethylene terephthalate (IPA-copolymerized PET) film (thickness: 100 μm) having a crystallinity of 0 to 3.9%, a Tg of 70° C., and 7 mol % of an isophthalic acid unit was used as a thermoplastic resin substrate.

An aqueous solution of a polyvinyl alcohol (PVA) resin (manufactured by The Nippon Synthetic Chemical Industry Co., Ltd., trade name: “Gohsenol (trademark) NH-26”) having a polymerization degree of 2,600 and a saponification degree of 99.9% was applied to one surface of the thermoplastic resin substrate, and was then dried at 60° C. so that a PVA-based resin layer having a thickness of 10 μm was formed. Thus, a laminate was produced.

The resultant laminate was uniaxially stretched in its longitudinal direction (lengthwise direction) between rolls having different peripheral speeds in an oven at 130° C. (aerial stretching treatment). The stretching ratio at this time was set to 1.8 times.

Next, the laminate was immersed in an insolublizing bath having a liquid temperature of 30° C. (aqueous solution of boric acid obtained by compounding 100 parts by weight of water with 3 parts by weight of boric acid) for 30 seconds (insolublizing treatment).

Next, the laminate was immersed in a dyeing bath having a liquid temperature of 30° C. (aqueous solution of iodine obtained by compounding 100 parts by weight of water with 0.1 part by weight of iodine and 0.7 part by weight of potassium iodide) so that a polarizing film to be finally obtained had a single axis transmittance (Ts) of 40 to 44% (dyeing treatment).

Next, the laminate was immersed in a cross-linking bath having a liquid temperature of 30° C. (aqueous solution of boric acid obtained by compounding 100 parts by weight of water with 3 parts by weight of potassium iodide and 3 parts by weight of boric acid) for 60 seconds (cross-linking treatment).

After that, the laminate was uniaxially stretched in its longitudinal direction between rolls having different peripheral speeds while being immersed in an aqueous solution of boric acid having a liquid temperature of 65° C. (aqueous solution obtained by compounding 100 parts by weight of water with 4 parts by weight of boric acid and 5 parts by weight of potassium iodide) (underwater stretching treatment). The stretching ratio at this time was set to 3.22 times.

After that, the laminate was immersed in a washing bath (aqueous solution obtained by compounding 100 parts by weight of water with 4 parts by weight of potassium iodide) for 5 seconds (washing treatment).

After that, as illustrated in FIG. 2, the laminate was dried while being conveyed with heat rolls equipped in the oven. Here, the temperatures of the first roll R1 and the second roll R2 from the upstream side were decontrolled, and the temperatures of the conveying rolls R3 to R6 were set to 60° C. In addition, hot air having a temperature of 60° C. was blown into the oven at a flow rate of 19 m/s. The total drying time was 101 seconds and a time of contact with the heat rolls was 54 seconds (about ½ of the total drying time).

Thus, a polarizing film having a thickness of 3 μm was produced on the thermoplastic resin substrate. It should be noted that the thermoplastic resin substrate after the underwater stretching treatment had a crystallinity of about 14%.

### Example 2

A polarizing film was produced in the same manner as in Example 1 except that the temperature of each of the conveying rolls R3 to R6 in the drying treatment was set to 85° C.

### Example 3

A polarizing film was produced in the same manner as in Example 1 except that the temperature of each of the conveying rolls R3 to R6 in the drying treatment was set to 90° C.

### Comparative Example 1

A polarizing film was produced in the same manner as in Example 1 except that the laminate was not brought into contact with the heat rolls in the drying treatment. It should be noted that the drying time was 36 seconds by changing the inside of the oven to a straight path without using the heat rolls.

### Comparative Example 2

A polarizing film was produced in the same manner as in Comparative Example 1 except that the temperature of the hot air was changed to 90° C. in the drying treatment.

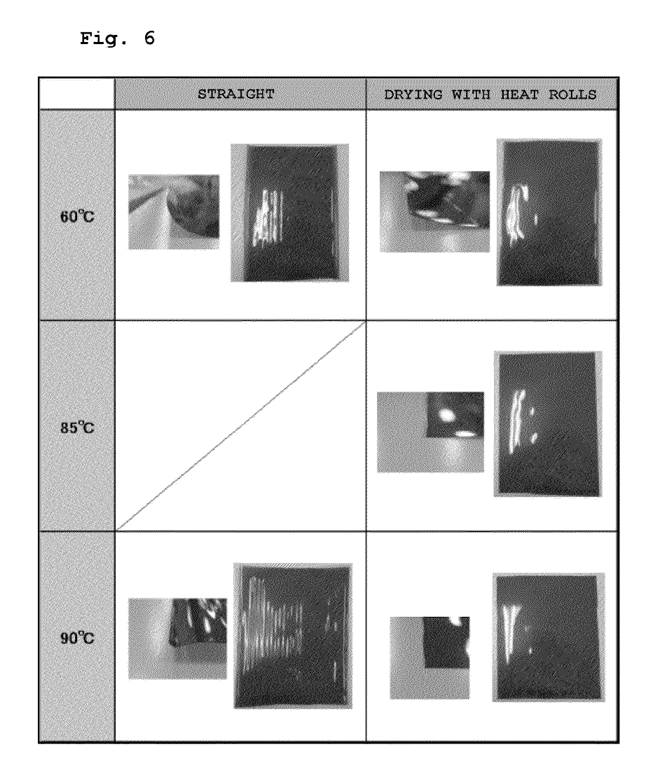

FIG. 6 show observation photographs of the optical laminates (thermoplastic resin substrates and polarizing films) obtained in Examples and Comparative Examples. In addition, Table 1 shows the evaluation results of curling and durability. Evaluation methods for curling and durability are as described below.

### 1. Curling

A test piece was cut out from the resultant optical laminate (measuring 10 cm in width by 10 cm in length). The resultant test piece was placed on a glass sheet so that the convex surface was on the lower side, and the heights of four corners of the test piece from the glass sheet were each measured. An evaluation was made on the corner showing the largest value out of the four corners.

### 2. Durability

The resultant optical laminate was placed in a thermostat bath at 80° C. and a thermo-hygrostat bath at 60° C. and 90% RH for 500 hours, and whether or not the thermoplastic resin substrate was peeled off from the polarizing film was observed.

### (Evaluation Criteria on Durability)

∘: No peeling was observed.
x: Peeling was observed.

TABLE 1

| | Drying conditions | | | | | |
|---|---|---|---|---|---|---|
| | | Temperature | Crystallinity | Curling | Durability | |
| | Method | (° C.) | (%) | (mm) | 80° C. | 60° C./90% RH |
| Example 1 | Heat roll | 60 | 17.0 | 8 | x | x |
| Example 2 | Heat roll | 85 | 22.7 | 0 | ∘ | ∘ |
| Example 3 | Heat roll | 90 | 20.9 | 0 | ∘ | ∘ |
| Comparative | Hot air | 60 | 14.6 | 16 | x | x |
| Example 1 | | | | | | |
| Comparative | Hot air | 90 | 21.5 | Unmeasurable | — | — |
| Example 2 | | | | | | |

Curling was suppressed in Examples using heat rolls, whereas curling occurred in Comparative Examples. In addition, substantially no wrinkling was observed in Examples, whereas wrinkling occurred along a conveying direction in Comparative Examples (in particular, Comparative Example 2). In Comparative Example 2, curling and wrinkling (in particular, wrinkling) remarkably occurred, and hence a curling degree could not be evaluated. As described above, a polarizing film excellent in external appearance was obtained in Examples.

Each of the optical laminates of Example 2 and Example 3 showing a large increase in crystallinity by the drying treatment was extremely excellent in durability.

The polarizing film of the present invention is suitably used for liquid crystal panels of, for example, liquid crystal televisions, liquid crystal displays, cellular phones, digital cameras, video cameras, portable game machines, car navigation systems, copying machines, printers, facsimile machines, clockes, and microwave ovens.

What is claimed is:

1. A method of manufacturing a polarizing film, comprising:
forming a polyvinyl alcohol-based resin layer on a thermoplastic resin substrate having a crystallinity of 7% or less to produce a laminate; and
subjecting the laminate to a wet treatment followed by a drying treatment with a heat roll.

2. A method of manufacturing a polarizing film according to claim 1, wherein the thermoplastic resin substrate comprises a polyethylene terephthalate-based resin.

3. A method of manufacturing a polarizing film according to claim 2, wherein the polyethylene terephthalate-based resin has an isophthalic acid unit.

4. A method of manufacturing a polarizing film according to claim 3, wherein a content ratio of the isophthalic acid unit is 0.1 mol % or more and 20 mol % or less with respect to a total of all repeating units.

5. A method of manufacturing a polarizing film according to claim 1, wherein the heat roll has a temperature of 50° C. or more.

6. A method of manufacturing a polarizing film according to claim 1, wherein the heat roll has a temperature of 80° C. or more.

7. A method of manufacturing a polarizing film according to claim 1, wherein the thermoplastic resin substrate after the drying treatment has a crystallinity of 15% or more.

8. A method of manufacturing a polarizing film according to claim 1, wherein the thermoplastic resin substrate after the drying treatment has a crystallinity of 20% or more.

9. A method of manufacturing a polarizing film according to claim 1, wherein the crystallinity of the thermoplastic resin substrate is increased through the drying treatment by 2% or more.

10. A method of manufacturing a polarizing film according to claim 1, wherein the wet treatment comprises a stretching treatment performed by immersing the laminate in an aqueous solution of boric acid.

11. A polarizing film, which is obtained by the method of manufacturing a polarizing film according to claim 1.

12. An optical laminate, comprising the polarizing film according to claim 11.

13. An optical laminate according to claim 12, further comprising the thermoplastic resin substrate.
